(19) United States
(12) Patent Application Publication
(10) Pub. No.: US 2010/0145922 A1
(43) Pub. Date: Jun. 10, 2010

(54) PERSONALIZED SEARCH APPARATUS AND METHOD

(75) Inventors: Yeo Chan Yoon, Daejeon (KR); Hyunki Kim, Daejeon (KR); Myung Gil Jang, Daejeon (KR); Jeong Heo, Daejeon (KR); YiGyu Hwang, Daejeon (KR); Chung Hee Lee, Daejoen (KR); Soojong Lim, Daejeon (KR); Hyo-Jung Oh, Daejeon (KR); Changki Lee, Daejeon (KR); Miran Choi, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/628,171

(22) Filed: Nov. 30, 2009

(30) Foreign Application Priority Data
Dec. 10, 2008 (KR) 10-2008-0125049

(51) Int. Cl. G06F 17/30

(52) U.S. Cl. 707/706; 707/728; 707/E17.014

(57) ABSTRACT

A personalized search apparatus includes: a model generating unit for generating a user favorites analysis model based on directory grouping information about directories stored in a user terminal and user behavior information; and a user favorites analysis model DB for storing the generated user favorites analysis model. Further, the personalized search apparatus includes a search engine for searching for a file relevant to an input query using an information search engine installed in the user terminal to generate search results; and a personalized search engine for re-ranking the search results generated by the search engine based on the user favorites analysis model to generate personalized search results.

### CROSS-REFERENCE TO RELATED APPLICATIONS

The present invention claims priority of Korean Patent Application No. 10-2008-0125049, filed on Dec. 10, 2008, which is incorporated herein by reference.

### FIELD OF THE INVENTION

The present invention relates to a search method based on a user query; and more particularly to, a personalized search apparatus and method of analyzing user favorites using classification information on directories in a user terminal and performing personalized search based on user favorites.

### BACKGROUND OF THE INVENTION

An information search system refers to a system capable of quickly and easily searching for data including desired information from among a great deal of documents, media, and the like. A great deal of websites and documents used at enterprises are target documents to be searched for.

Unlike an information search system for searching web sites and/or data networks, a desktop media search system refers to a search system searching for desired data from data such as texts, images, audio files, video files, and other data that are stored in a personal desktop computer. The information search system and the desktop media search system receive a user query as an input and show ranked data including information desired by a user. In order to increase user satisfaction, it is important to show data highly relevant to information for which the user searches for.

In general, the information search and the desktop media search receive a user query as an input and search for data most relevant to the user query so that information search demand of the user may be satisfied. The user query usually includes about one to five keywords representing the user demand for information search. However, it is difficult to completely satisfy the user demand for information search by using only a few words and therefore the user cannot obtain satisfactory search results. In order to overcome the above problem, the personalized search method analyzes user favorites in advance and automatically ranks user favorite data as search results in high ranking and user non-favorite data in lower ranking to satisfy the user demand for the information search.

In conventional personalized search methods, a past behavior of the user on web sites is tracked to analyze the user favorites. Among search results for which the user searched in the past, data to which the user clicked to access, that is, user search history is analyzed so that data in which the user was interested is applied. Moreover, to determine detailed user favorites and to apply the applied user favorites to search results, a data grouping strategy is constructed in view of many users in advance.

The conventional personalized search method has roughly two drawbacks.

First, the user favorites are classified using the data grouping strategy constructed in view of many users. Since the user favorites grouping is not focused on individual users, detailed analysis of the user favorites which the user wishes and the personalized search using the analysis cannot be performed. When data is grouped into several categories such as games, economics, and politics in the conventional personalized search method, a certain user may wish to group data into more detailed categories. The user may wish to group data into video games, online games, and non-games and that the searched video games may be assigned high rankings. However, the conventional personalized search method simply restricts the user favorites to the games and ranks overall documents of the search results related to the games in high ranking. As described above, the conventional personalized search method does not individually analyze documents according to the user favorites.

Second, the personalized search method using the user search history assumes that information upon which a user clicks and accesses is information in which the user is interested and uses the information to analyze what issue the user is interested in.

The conventional search method using a strategy of grouping user favorites, which is built in view of many users, cannot perform individual analysis of user favorites because the user favorites are simply limited to games and all documents of the search results relevant to games are ranked in high ranking.

Since, in the conventional personalized search method using user search history, the user may access unknown data to check the contents of the data, data in which the user is not interested may be included in the user favorites.

### SUMMARY OF THE INVENTION

In view of the above, the present invention provides a personalized search apparatus and method of tracking and grouping user favorites using data, which a user terminal directly stores and groups, in view of the user to improve search satisfaction.

In accordance with a first aspect of the present invention, there is provided a personalized search apparatus including: a model generating unit for generating a user favorites analysis model based on directory grouping information about directories stored in a user terminal and user behavior information; a user favorites analysis model DB for storing the generated user favorites analysis model; a search engine for searching for a file relevant to an input query using an information search engine installed in the user terminal to generate search results; and a personalized search engine for re-ranking the search results generated by the search engine based on the user favorites analysis model to generate personalized search results.

In accordance with a second aspect of the present invention, there is provided a personalized search method including: generating a user favorites analysis model based on directory grouping information about directories stored in a user terminal and user behavior information; storing the generated user favorites analysis model; searching for a file relevant to an input query using an information search engine installed in the user terminal to generate search results; and re-ranking the search results generated by the search engine based on the user favorites analysis model to generate personalized search results.

In accordance with an embodiment of the present invention, the favorites analysis model is generated based on the directory information that the user directly stores and groups and the user behavior information and the search results provided by a common search engine are re-ranked based on the favorites analysis model so that search speed can be increased, search performance for media can be improved, and search results suited to user interests can be provided.

### BRIEF DESCRIPTION OF THE DRAWINGS

The objects and features of the present invention will become apparent from the following description of preferred embodiments, given in conjunction with the accompanying drawings, in which:

FIG. 1 is a block diagram illustrating a personalized search apparatus in accordance with an embodiment of the present invention;

FIG. 2 is a view illustrating a general computer directory;

FIG. 3 is a view illustrating a metadata structure in a media file; and

FIG. 4 is a flowchart illustrating a personalized search method in accordance with the embodiment of the present invention.

### DETAILED DESCRIPTION OF THE EMBODIMENTS

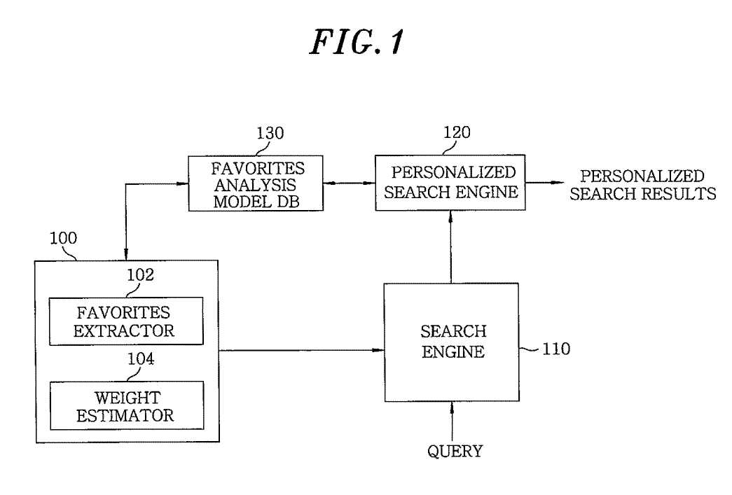

Hereinafter, embodiments of the present invention will be described in detail with reference to the accompanying drawings which form a part hereof. FIG. 1 shows a block diagram of a personalized search apparatus in accordance with the embodiment of the present invention including a model generating unit 100, a search engine 110, a personalized search engine 120 and a favorites analysis model database (DB) 130.

The model generating unit 100 collects information on directories stored in a user terminal, e.g., a desktop computer, i.e., directory grouping information and user behavior information and generates a user favorites analysis model to store the generated user favorites analysis model in the favorites analysis model DB 130 such as a storage unit, e.g., a memory, a hard disk and the like provided in the user terminal. The model generating unit 100 includes a favorites extractor 102 and a weight estimator 104.

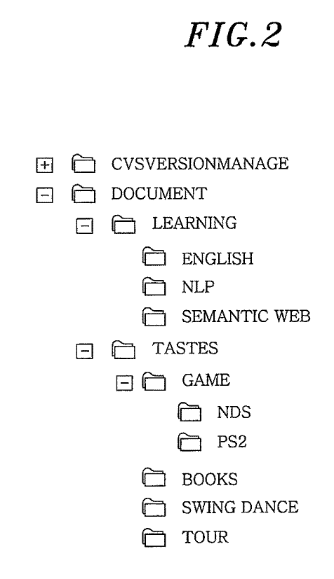

The favorites extractor 102 extracts directory grouping information using directories stored in the user terminal. The directory grouping information, as illustrated in FIG. 2, refers to directories that a user directly groups and stores and information about files included in the directories. In other words, the favorites extractor 102 checks information about the directories that the user directly groups and what data the user is interested in and collects the same, to extract the user favorites.

Further, the favorites extractor 102 obtains the user favorites by indexing files contained in the directories. The indexing refers to the extraction of typical keyword included in the files.

In accordance with the embodiment of the present invention, name and content of a file, the name of a directory including the file and the like are utilized to extract the typical keywords.

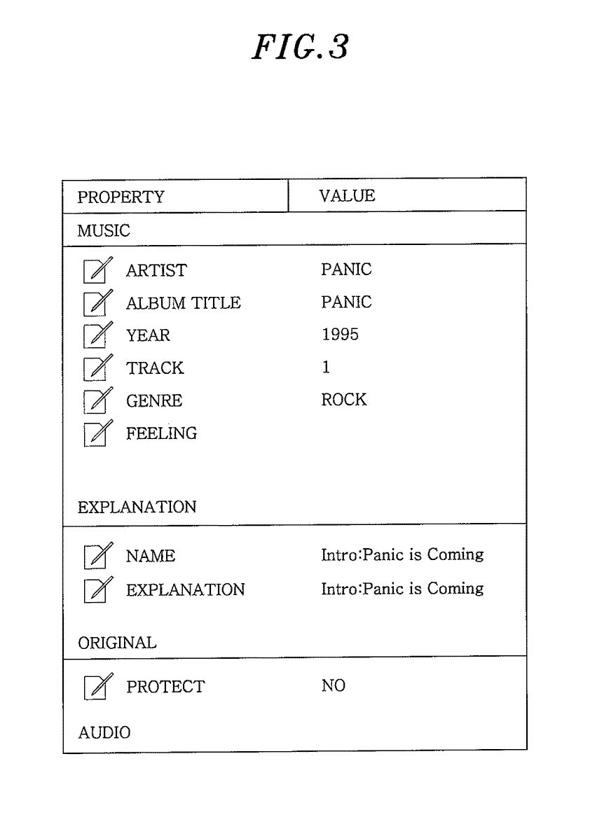

As illustrated in FIG. 3, in accordance with the embodiment of the present invention, metadata information including supplementary information such as a title, an artist name and the like of a song of a multimedia file such as MP3, AVI are utilized for indexing. The favorites extractor 102 of the model generating unit 100 provides the user favorites obtained by indexing as the typical keyword to the personalized search engine 120 via the favorites analysis model DB 130.

The model generating unit 100 estimates weights of respective files and directories, which are stored in the user terminal, to provide weight to the favorites of individual users and the weight estimator 104 estimates the weight based on user behavior information. The user behavior information includes the number of time a user has accessed a file and how long the user has been accessed the file (in a case of a document, work time of the user while the document is being opened). That is, the weight estimator 102 of the model generating unit 100 estimates weights of respective files using the user behavior information by Equation 1 as follows:

DS=log(1+time)+log(1+hitfreq)−log(1+timeₘₐₓ)+log(1+hitfreqₘₐₓ) [Equation 1]

where DS: weight of file,

time: how long file was accessed,

hitfreq: number of times file has been accessed,

timeₘₐₓ: the longest access time of file, and

hitfreqₘₐₓ: number of times the most frequently accessed file has been accessed.

Moreover, the weight estimator 104 of the model generating unit 100 estimates weight of a directory including corresponding files by equation 2 using the weights of the respective files estimated by equation 1:

$${T}_{W} = \frac{1}{\vert D \vert} {{\sum }_{i}}^{D} {DS}_{i} , \qquad [ Equation 2 ]$$

where D: document set contained in a directory, and

T_{w}: weight of a file.

Referring to Equation 2, the weight estimator 104 divides a sum of weights of the respective files (documents) in a directory by the number of files (the number of documents) to estimate the weight of a directory.

The model generating unit 100 generates a favorites analysis model using the user favorites extracted by the favorites extractor 102 and the weights of files and directories estimated by the weight estimator 104 to form the favorites analysis model DB 130.

The search engine 110 searches for a file relevant to an input query using an information search engine installed in the user terminal such as a vector space model, Okapi model and the like. That is, the search engine 110 estimates relevance between words used in the query and a document to be searched for and outputs search results in which documents are ranked according to the estimated relevance.

The personalized search engine 120 re-ranks the search results generated by the search engine 110 based on the favorites analysis model of the favorites analysis model DB 130, which is generated by the model generating unit 100, to generate personalized search results.

In other words, the personalized search engine 120 provides the user favorites stored in the favorites analysis model DB 130 as a typical keyword, that is, re-ranks the search results in which only the relevance is estimated using the typical keyword that the user favorites. The weight varies depending on the user favorites and data having high weight among data in the search results are assigned high rankings. Specifically, weights of each data in the search results are extracted using weight information in the favorites analysis model DB 130 and a directory or a file having high weight is assigned to have a high ranking using the extracted weights.

More specifically, the personalized search engine 120 estimates a personalized ranking scores which are relevance between the search results by the search engine 110 and the user favorites based on the favorites analysis model DB 130 using Equation 3, and ranks and outputs the personalized search results having high personalized ranking scores in high rankings:

PRS(R₁)=max(log CosSim(Rᵢ, T)+log T_{w}), [Equation 3]

where PRS: ranking score of personalization,

Rᵢ: search results of ranking i (search results by an existing search engine),

T: index information of respective directories, and CosSim: cosine similarity function.

The personalized search apparatus in accordance with the embodiment of the present invention can obtain search results in which user intent is clearly applied by performing the personalized search using the information about directories stored and grouped in the user terminal.

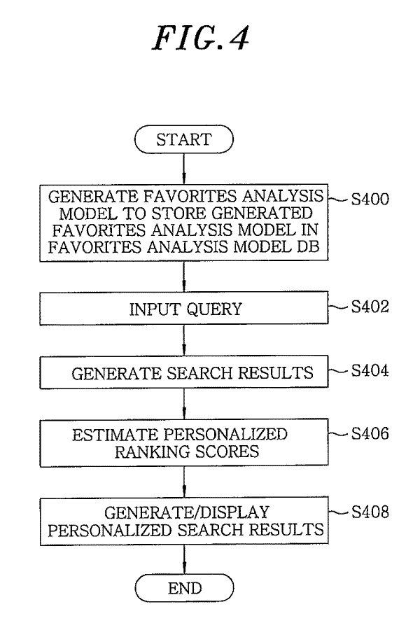

FIG. 4 is a flowchart illustrating a personalized search method in accordance with an embodiment of the present invention.

Referring to FIG. 4, the model generating unit 100 generates the favorites analysis model DB 130 using the user favorites and the weights provided based on the user favorites by the favorites extractor 102 and the weight estimator 104 in step S400.

In step S400, the model generating unit 100 determines themes which the user directly groups and stores, and analyzes the user favorites using the indices of the files stored in directories. Then, in order to provide weights to every user favorite, the model generating unit 100 estimates weights of respective files using the number of access time and access time to the respective files (i.e., user behavior information) to estimate weights of respective directories including the respective files using the estimated weights of respective files.

Thereafter, the model generating unit 100 provides the weights with respect to each file and directory based on the user favorites using the estimated weights of the respective files and directory, and generates the favorites analysis model to store the generated favorites analysis model in the favorites analysis model DB 130.

When a query is inputted by the user in step S402, the search engine 110 searches for a file (document) related to the input query using a search engine of the user terminal, such as Vector Space Model and Okapi Model, that is, estimates relevance of a document to be searched for to words used in the query to output search results ranked by the estimated relevance to the personalized search engine 120 in step S404.

Then, the personalized search engine 120 estimates the personalized ranking scores which are the relevance between the search results and the user favorite of every file using the favorites analysis model DB 130 in step S406, generates the personalized search results by re-ranking the search results based on the estimated personalized ranking scores of the files to display the generated personalized search results through the user terminal in step S408.

Further, the favorites analysis model DB 130 is updated by the user behavior information frequently monitored by the model generating unit 100, such as the number of times a file has been accessed and file access time.

The personalized search apparatus in accordance with the embodiment of the present invention may be implemented by computer-readable code, which is recorded in a computer readable recording medium. The computer-readable recording medium includes all kinds of recording media in which data readable by computer systems are stored, such as ROM, RAM, CD-ROM, a magnetic tape, a hard disk, a floppy disk, a flash memory, an optical data storage, and a medium in the form of a carrier wave, e.g., transmission on internet. The computer-readable medium may be stored as codes distributed in computer systems, which are connected to each other through a computer communication network, and executed by distributed processing systems. Font ROM data structure used in the present invention may be implemented as computer-readable code stored in a recording medium such as computer-readable ROM, RAM, CD-ROM, a magnetic tape, a hard disk, a floppy disk, a flash memory, an optical data storage, and the like, which are read by a computer.

While the invention has been shown and described with respect to the embodiments, it will be understood by those skilled in the art that various changes and modification may be made without departing from the scope of the invention as defined in the following claims.

What is claimed is:

1. A personalized search apparatus comprising:
a model generating unit for generating a user favorites analysis model based on directory grouping information about directories stored in a user terminal and user behavior information;
a user favorites analysis model DB for storing the generated user favorites analysis model;
a search engine for searching for a file relevant to an input query using an information search engine installed in the user terminal to generate search results; and
a personalized search engine for re-ranking the search results generated by the search engine based on the user favorites analysis model to generate personalized search results.

2. The personalized search apparatus of claim 1, wherein the model generating unit includes:
a favorites extractor for obtaining directory grouping information using directories stored in the user terminal to extract the user favorites by indexing files contained in the directories; and
a weight estimator for estimating weights of respective files and each directories, which are stored in the user terminal to provide the weight to the favorites of individual users.

3. The personalized search apparatus of claim 2, wherein the favorites extractor indexes the files using metadata file information in the files when the files stored in the directories are multimedia files.

4. The personalized search apparatus of claim 2, wherein the weight estimator estimates weights of respective files using the number of times a file has been accessed in each directory to provide different weights to different user favorites in the favorites analysis model DB to provide the weights of the user favorites using the estimated weights.

5. The personalized search apparatus of claim 4, wherein the weights of respective files are estimated from the below equation:
DS=log(1+time)+log(1+hitfreq)−log(1+timeₘₐₓ)+log(1+hitfreqₘₐₓ)
where DS: weight of file,
time: how long file is accessed,
hitfreqₘₐₓ: number of times file has been accessed,
timeₘₐₓ: the longest access time of a file, and
hitfreqₘₐₓ: number of times the most frequently accessed file has been accessed.

6. The personalized search apparatus of claim 5, wherein the weight estimator estimates a weight of a directory including a corresponding file using the weight of each file from the below equation:
$${T}_{W} = \frac{1}{\vert D \vert} {\sum }_{i}^{D} {DS}_{i} ,$$
where D: document set contained in a directory; and
T_{w}: weight of a file.

7. The personalized search apparatus of claim 6, wherein the personalized search engine estimates a personalized ranking scores which are relevance between the search results by the search engine and the user favorites using the favorites analysis model DB by the below equation, and re-ranks the search results to output the personalized search results:
PRS(Rᵢ)=max(log CosSim(Rᵢ, T)+log T_{w}),
where PRS: ranking score of personalization,
Rᵢ: search results of ranking i (search results by an existing search engine),
T: index information of respective directories, and
CosSim: cosine similarity function.

8. A personalized search method comprising:
generating a user favorites analysis model based on directory grouping information about directories stored in a user terminal and user behavior information;
storing the generated user favorites analysis model;
searching for a file relevant to an input query using an information search engine installed in the user terminal to generate search results; and
re-ranking the search results generated by the search engine based on the user favorites analysis model to generate personalized search results.

9. The personalized search method of claim 8, wherein generating the favorites analysis model comprises:
obtaining directory grouping information using directories stored in the user terminal to extract the user favorites by indexing files included in the directories;
estimating weights of the respective files using the number of times which respective files are accessed and accessing time of the respective files;
extracting the weights of the respective directories including the respective files using the weights of the respective files; and
generating the favorites analysis model by providing different weight to different user favorites using the extracted weights of the respective files and directories.

10. The personalized search method of claim 8, wherein generating the personalized search results includes:
estimating personal ranking score of respective files which is relevance between the search results of the search engine and the user favorites in the search results using the favorites analysis model DB; and
generating the personalized search results by re-ranking the search results based on the estimated personalized ranking scores of the respective files.
